(19) United States
(12) Patent Application Publication
(10) Pub. No.: US 2013/0060081 A1
(43) Pub. Date: Mar. 7, 2013

(54) SEGMENTED MASSAGE SYSTEM

(71) Applicants: Catherine Ann Carter, Carrollton, TX (US); Alexander Vickers, Irvine, TX (US)

(72) Inventors: Catherine Ann Carter, Carrollton, TX (US); Alexander Vickers, Irvine, TX (US)

(21) Appl. No.: 13/597,064

(22) Filed: Aug. 28, 2012

Related U.S. Application Data
(60) Provisional application No. 61/530,193, filed on Sep. 1, 2011.

(51) Int. Cl. A61H 19/00

(52) U.S. Cl. 600/38

(57) ABSTRACT

A massage device with a first and second section, a vibration isolation device, positioned between the first and second section, designed to dampen vibrations occurring in the first section from fully impacting the second section. There is also a first and second vibrator motor positioned in the first and second section respectively, designed to be independently operated from each other. There is a first and second lubrication port, located in the first and second section respectively. There is a lubrication pump module located in the massage device, designed to independently provide lubrication to the first and second lubrication port.

### CROSS-REFERENCE TO RELATED APPLICATIONS

This invention has no claims of priority, under 35 U.S.C. §120, to any U.S. Provisional Patent, which would be incorporated by reference herein. This invention also claims no priority, under 35 U.S.C. §119, to any foreign Patent Application, which would be incorporated by reference herein. This application is not a Divisional application of, under 35 U.S.C. §121, and claims no priority under 35 U.S.C. §121, to a U.S. Non-Provisional Application.

### BACKGROUND OF THE INVENTION

1. Field of the Invention

The present invention relates to the health and relaxation industry. In particular, this invention is related to massage devices incorporating features like motors, lubrication and such.

2. Description of the Related Art

In the related art, it has been known to use vibrational devices for massages. Additionally, it is also known to use lubricants in conjunction with vibrational devices to lubricate the skin to allow the vibrator to easily glide thereover.

Some improvements have been made in the field. Examples of references related to the present invention, but not teaching alone or in combination the present invention are described below, and the supported teachings of each reference are incorporated by reference herein:

U.S. Pat. No. 6,350,230: STIMULATION AID DEVICE, issued Feb. 26, 2002 to KONTOS, discloses a sexual aid device for producing sexual stimulation having an elongated upper member, an elongated lower member, a means for removably securing the upper and lower members together, a tube member, and a compression means for ejaculating liquid from the tube member. An upper end of the upper member has an aperture therethrough. The elongated lower member has a compartment therein for one or more batteries for powering the device. The tube member has a compressible liquid containment unit on a lower end thereof. A hollow neck member extends upward from the liquid containment unit, the hollow neck member being in fluid communication with the liquid containment unit. The neck member has an open upper end. During use the tube member is positioned inside the device such that the open upper end of the neck member is inserted in the aperture of the upper member. The compression means is configured and positioned to compress the liquid containment unit to thereby ejaculate liquid from the tube member. The device is preferably provided with a vibration means, a timing unit, and a heating element, all of which may be selectively used as needed when using the device to provide sexual stimulation. Methods of using the device are also provided.

U.S. Pat. No. 7,163,508: STIMULATION LUBRICATING AID, issued Jan. 16, 2007 to WASHINGTON, discloses a lubricating insertable sexual aid comprising a shaft having a throughbore extending therethrough for retaining a lubricant therein. A head having an egress aperture extending through a tip thereof is removably connected to a first end of the shaft. The aid further includes means received within the throughbore at an end opposite of the head for dispensing the lubricant. Upon insertion into an orifice and activation of the dispensing means, the dispensing means exerts a pressure on the lubricant thereby causing the lubricant to be output via the egress aperture and to be evenly distributed over an exterior surface of each of the head and shaft.

U.S. Pat. No. 7,527,589: THERAPEUTIC PROSTHETIC DEVICE, issued May 5, 2009 to SQUICCIARINI, discloses a male prosthetic device configured to be worn on a flaccid, partially-erect or erect penis which transmits tactile sensations through a stimulation material to the surface of the penis. The device includes prosthesis with an outer surface and in inner chamber, a microprocessor, one or more sensors and one or more stimulation materials. The outer surface is configured to appear as a penis or other elongate body with hard or soft materials, with optional stimulation materials and sensors. The inner cavity is lined with stimulation material configured to contact the surface of the penis. Sensors for detecting sensation or direction can be disposed within, on, or separate from the device transmit signals electrically or wirelessly to the microprocessor, which is programmed to generate stimulation sensations in response to signals from the sensors, stimulation materials, or controllers that are transmitted to the stimulation material.

U.S. Patent Application Publication No. US2005/0033112: STIMULATION AID DEVICE by Jeffrey Francis; et al., discloses a sexual aid device includes a housing having a generally cylindrical base and central portion and an upper portion defining a closed upper end. The base includes an open lower end and at least the base and central portion are hollow. The housing is fabricated of a lubricious glass-based single piece of material. An electric motor is mounted in the hollow central portion of the housing and vibrator means including a block and an eccentric drive therefore is coupled to the motor. A battery means is disposed in the hollow base of the housing and is operably coupled with the motor. The motor and battery means are connected in series circuit and an end sealing means including a cap mounted on the open end of the base for releasably sealing the open end so that the hollow interior of the housing is waterproof when the cap is mounted on the base. The end sealing means provides an external switch means operably coupled with the battery means and the motor for selectively energizing the motor to drive the block in eccentric rotation to thereby cause the housing to vibrate.

U.S. Patent Application Publication No. US2005/0228219: DUAL-MOTION AUTO-STIMULATION DEVICE, by Jewell, discloses a device designed to take rotary power from an external power source such as a cordless electric screwdriver and transmit that energy into both rotary and reciprocating linear activation of sexual devices used by both males and females for the purpose of masturbation and auto-stimulation is disclosed. The combination of rotational stimulation with reciprocating linear stimulation is apparently remarkably satisfying despite the absence of such stimulation during normal person-on-person sexual contact. The device is simple, light weight, small, powerful, modestly priced, handheld or hands-free, user serviceable, hygienic, gender neutral, and sexual orientation neutral, convenient, rugged, multi-motion, safe, reliable, quiet, fully submersible, positionally versatile and sexually satisfying.

U.S. Patent Application Publication No. US2009/0281373: STIMULATION AID DEVICE AND METHOD, by MARK, discloses a sexual aid device and method for inserting and occupying space within a human female's vagina to provide a sensation of increased fullness to the female and a sensation of increased tightness and friction to a penis of a human male during sexual intercourse, thereby enhancing sexual arousal of both the female and the male. The sexual aid can be a member having a bulbous end for insertion and a tapered end for externally grasping and manipulating the member. The tapered end may include a hooked protrusion for providing anal stimulation to the female. The member may contain one or more vibrating devices. The member may further include a generally planar surface featuring a trough and can include two arced terminuses oriented in opposing directions. An internal pellet-rotating device may be installed within the tapered end of the member to produce mechanical friction in and around the vagina.

U.S. Patent Application Publication No. US2010/0076257: STIMULATION AID SYSTEM, by DEALVA, discloses a sexual aid device formed of a substantially U-shaped, member having a proximal end adapted for engagement within the vagina of a user distal end positioned to oppose the proximal end in a biased engagement with intra vaginal and external sexually sensitive surfaces of the user's body. A skeletal member running axially within said U-shaped member may be employed to vary the force of the biased engagement and reshape the U-shaped member. A projecting elongated member adjacent to the distal end of the U-shaped member is engageable by the user or body contact with a second user to impart force to the U-shaped member for sexual stimulation.

U.S. Pat. No. 5,842,970: NON-SURGICAL EXTERNAL PENILE PROSTHETIC DEVICE, by LAKUSIEWICZ, discloses an external penile prosthetic device is adapted to be worn on the groin and suprapubic areas of the wearer. The device has a generally tubular outer wall made from a flexible material, having an open proximal end and a closed distal end, the exterior of the outer wall being configured to resemble an erect human penis. The device also has a generally tubular inner wall made from a flexible material having a different degree of durameter firmness than that of the outer wall and an open proximal end and a closed distal end. The inner wall is disposed spacedly and coaxially inside the outer wall and is sealed thereto at least at their respective proximal ends to define a chamber therebetween. A viscous fluid fills the chamber between the outer wall and the inner wall. A flange is disposed around and connected to the proximal end of the outer wall of the prosthetic device for mounting the device over the groin and suprapubic areas of the wearer.

U.S. Pat. No. 5,725,473: STIMULATION AID, by TAYLOR, discloses a sexual aid including a housing, mounted on detachable legs and containing a motor that urges a dildo, including vibration means, to describe an arcuate path generally coincident with an orifice, such as a vagina. A first stimulator, also containing vibration means, is superposed above the dildo and is urged through an arcuate path concentric with and radially spaced inwardly from that of the dildo, cyclically contacting a clitoris. The sexual aid may include means for introducing a vacuum between the first stimulator and the clitoris. A second stimulator, also containing vibration means, is subjacent the dildo and is urged through an arcuate path concentric with and radially spaced outwardly from that of the dildo, cyclically contacting an anus. The sexual aid includes remotely locatable stimulators that may be placed in contact with a user's nipples and areolae. The sexual aid also provides a vacuum phenomenon between the remotely locatable stimulators and the nipples.

U.S. Patent/Publication No. 2006/0247493: VIBRATING STIMULATION AUXILIARY RING CAPABLE OF PREVENTING POWER FROM ACCIDENTALLY BEING TURNED ON, by CHEN, discloses a vibrating sex auxiliary ring capable of preventing power from accidentally being turned on includes a ring and a vibrator formed on the ring. The vibrator includes a housing, a motor formed in the housing comprising a bias round in an axis of the motor, a battery formed in the housing comprising a first end coupled to a first power input end of the motor and a second end coupled to a conductive leaf spring that is disposed near a second power input end of the motor, and a stick comprising a first end projecting from the housing and a second end disposed between the conductive leaf spring and the second power input end of the motor in the housing for electrically connecting the conductive leaf spring and the motor when the first end of the stick is pulled out from the housing.

What is needed is a segmented stimulation system. Additionally, there is a need for a device that solves one or more of the problems described herein and/or one or more problems that may come to the attention of one skilled in the art upon becoming familiar with the current specification and appended drawings.

Additionally, what is needed is a method or device that allows massaging of a person where different parts of the massage device have different independent operations.

Moreover, what is needed in the art of massaging is a method, device, or system that enables in different locations thereon such features as vibration, lubrication and other useful contrivances.

### SUMMARY OF THE INVENTION

The present invention has been developed in response to the present state of the art, and in particular, in response to the problems and needs in the art that have not yet been fully solved by currently available massage systems, devices and methods. Accordingly, the present invention has been developed to provide a segmented stimulation system. Additionally, there has been developed a method or device that allows massaging of a person where different parts of the massage device have different independent operations. Moreover, what has been developed is a method, device, or system that enables the different locations to have features like vibration, lubrication and heat, in addition to other useful contrivances.

Features of the invention may include a massage device with a first and second section, a vibration isolation device, positioned between the first and second section, and designed to dampen vibrations occurring in the first section from fully impacting the second section. There is also a first and second vibrator motor positioned in the first and second section respectively, designed to be independently operated from each other. There is a first and second lubrication port, located in the first and second section respectively. There is a lubrication pump module located in the massage device, designed to independently provide lubrication to the first and second lubrication port. There is a first and second temperature module, located in the first and second section respectively. There is a control module, located in the massage device, designed to independently provide independent activation control over the first and second temperature module. There is a lubrication storage container, coupled to the lubrication pump module, designed to supply lubrication thereto. There is a control module, designed to provide functional independent control to the temperature module, lubrication pump module, and the first and second vibrator motor respectively; and a control panel, positioned on the outside surface of the massage device, designed to provide tactile control switches so the user may individually control the operation of the first and second temperature module, first and second lubrication port, and the first and second vibrator motor positioned in the first and second sections respectively.

While the device and methods described in the present invention have proven to be particularly useful in the art of massage therapy, those skilled in the art can appreciate that the device and methods can be used in a variety of different applications.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 illustrates a cross section of one embodiment of the illustrated invention;

FIG. 2 illustrates an exploded view of one embodiment of the illustrated invention of FIG. 1;

FIG. 3 illustrates a side view of one embodiment of the illustrated invention of FIG. 1.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified, for example, as “another embodiment” or “an embodiment” the identified embodiment is independent of any other embodiments characterized by the language “another embodiment.”

The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of”.

The basis of the present invention is built around the idea of providing a relaxing and stimulating massage. It is noted that throughout the specification the general invention is referred to as a “vibrator”. This verbiage is chosen as a convenience and not used by way of definition of the device. Other wording that could also be used is: “massager,” “stimulator”, “heater”, and other names.

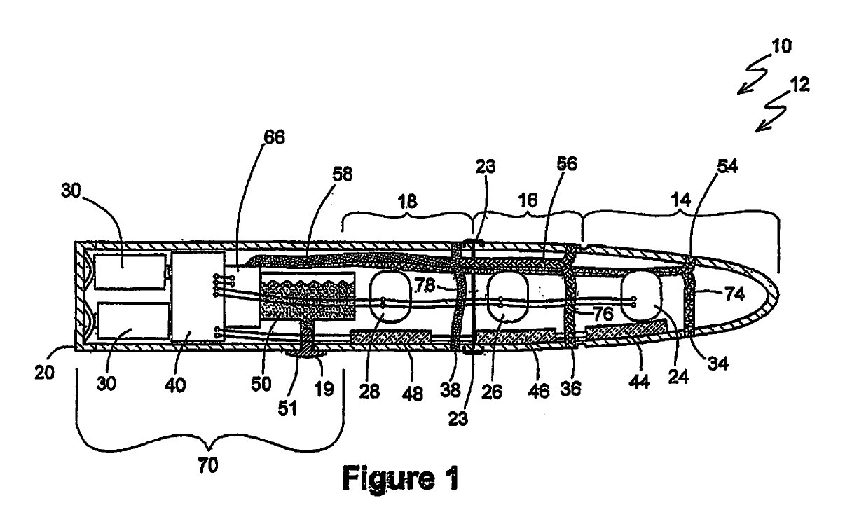

Regarding FIG. 1, there is illustrated an embodiment representing the generic design of vibrators used in the massage industry. Specifically, the massage device 10 includes a housing 12 that encapsulates all of the relative parts described herein. The housing 12 includes at least two sections, wherein three are illustrated for instructional purposes only; a nose section 14, a middle section 16, and a rear section 18.

Each section, nose, middle and rear may be divided by any number of means, as illustrated there are circumferential separators 13 and 23. In particular, in one embodiment, the nose separator 13 is illustrated as a shallow groove positioned between the nose and middle sections. This groove is designed to dampen any transference of vibration, or heat from one section to the next.

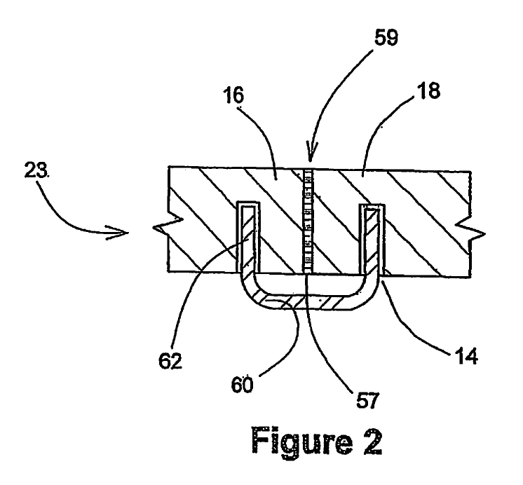

Referring to FIG. 2, there is a second circumferential separation embodiment, which illustrates that the middle separator 23 may be a complete brake 59 between the two separate body pieces (middle 16 and rear 18). Thereby, there would be a coupling in the form of a U-shaped ring 60 that holds the two separate body pieces together by the ends 62 of the U-shape, which would be lodged into grooves 64 that would be located on either section 14 and 16 a short distance from the interface 59 of the two independent sections 16 and 18 (middle and rear). There may be a dampening device 57, in the form of resilient material, placed therebetween the two independent pieces to further the isolation between the sections (rear, middle, and nose).

Referring back to FIG. 1, each section may have identical vibrator 10 features. Specifically, in a feature of one embodiment, there is a known vibration creation motor 24, 26, and 28 positioned in nose 14, middle 16 and rear 18 sections respectively. Thus, the vibrator 10 is designed so that when vibration creation motor 24 is activated, it is intentionally designed to create little effect in the other two sections and have maximal effect in the section where the activated motor is positioned.

Additionally, each vibrator section may have in one embodiment, identical lubrication ports 34, 36 and 38 respectively placed in the nose 14, middle 16 and rear 18 sections. Thus, the lubrication ports are designed similar to the motors, whereby lubrication of one section will have little effect on the other sections. A skilled artisan will realize the benefit of not lubricating all sections at the same time, since each section may not be in need of lubrication at the same time.

Moreover, each section 14, 16 and 18 may have in one embodiment, identical temperature applicators 44, 46 and 48 respectively located in therein. The temperature applicators are designed similar to the motors and lubrication ports, in that the separate temperature modules may apply different temperatures to each section. Again, a skilled artisan will realize the benefit of having the ability to control the temperature (heat or cold) that is being applied to each section.

There is a central control module 70 positioned at one end of the vibrator device 10 that houses several key elements. For example, there may be a lubricant storage container 50, with an associated lubricant filling tube or port 51, and a respective removable tube plug 19. The plug 19 is designed to be opened to enable a user to refill the lubricant storage container 50, and thereby be replaced to contain the lubricant therein. There may also be a lubricant pump module 66, designed to independently and separately pump lubricant to the respective lubricant ports 34, 36 and 38, through respective lubricant tubes 74, 76 and 78. There may be a control module 40, designed to control the operation of the lubricant pump module in response to the desires of the user. A skilled artisan of lubricant pump design may provide any number of configurations to accomplish the desired and stated purposes. There is also a power module 30, designed to provide power to the various modules, motors, controls and such. The power module may be in the form of known batteries, as illustrated. Central control section 70 may have a removable cap 20 that my be designed to allow the user access to all or some of the operational elements inside the vibrator 10 as is customary in the industry of hand held electrical appliances.

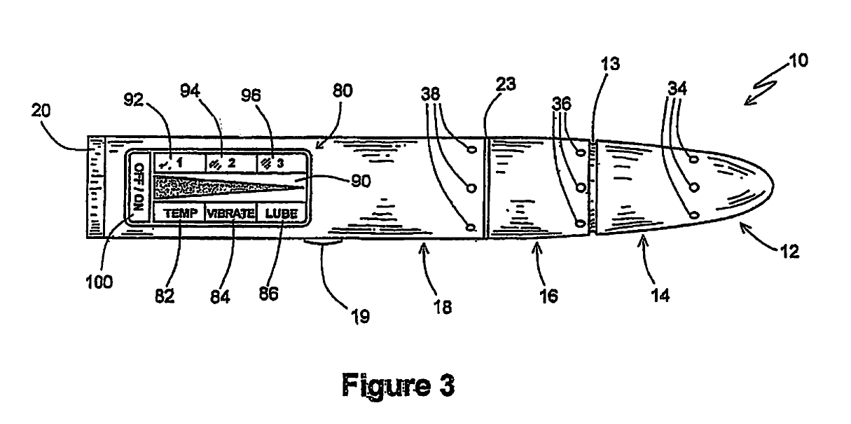

Referring now to FIG. 3, there is illustrated an embodiment of an exterior side view of the vibrator 10. Specifically, there is illustrated one embodiment of various positioning of the lubricant ports 34, 36 and 38 in their respective sections—nose 14, middle 16 and rear 18 sections. Additionally, there is illustrated one embodiment of the groove separator 13, and U-shaped coupling 23. There is also illustrated one embodiment of a control panel 80, designed to allow the user to control the various features of the vibrator 10 through a touch panel 80.

FIG. 3 further illustrates one embodiment of the control panel 80. Specifically, in this illustrated embodiment, there is in the lower left side a touch activated switch 82 for activating the temperature, designated as “TEMP”. There is in the lower middle of the screen a similar switch for activating the vibration control 84, designated as “VIBRATE”. There is in the lower right, a similar lubrication switch 86 for activating the lubrication system, designated as “LUBE”. There is a sliding control switch 90 located in the middle of the screen and extending from the left (base of triangle) to the right (apex) of the panel 80, having the overall shape of a pyramid. The sliding control switch 90 is designed to regulate the amount, intensity, speed of the various features of the temperature, vibration and lubrication systems; where touching the apex will activate at a low level, and activation at the base of the pyramid is turning on maximum power. Although, the opposite arrangement may also be suitable. There are also switches for each physical section of the massage device 10, located along the top of the control panel 80. The section switches are similarly designed as in the other switches. The section switches are designed to turn on or off the nose 14 with button 3, middle 16 with button 3, and the rear section 18 with button 1, which are designated as element numbers 96, 94, and 92 respectively.

In operation, regarding one embodiment of the illustrated invention, there is an increased flexibility derived from this design. For example, it is possible to have lubrication emanating from the nose section, vibration in the middle section, and heat in the rear section. Whereby, the vibration can be increased in the middle section, and the heat can be decreased in the rear section after starting a massage session. Specifically, by switching on button 1, then pressing lube, lubrication will be emitted from the nose section as long as the lube button is pressed. By pressing button 2, and then pressing vibrate, and sliding the slide button 90 from the apex to a middle section of the pyramid, you will get the middle section to vibrate at a medium speed. Finally, by pressing button 3, then TEMP, and thereby leaving the initial setting at the top of the pyramid, you will get slightly warm emanation from the rear section.

To activate all three features, one skilled in the art will appreciate the ease of the process. For example, by pressing button 1, the nose section 14, then pressing lube, vibrate 84 and sliding the adjustment switch 90 all the way to the bottom of the primed, and then touching the TEMP switch and also sliding the adjustment switch 90 all the way to the bottom, you will get maximum heat, maximum vibration and one application from the lubrication (one being the times the lubrication button 86 was touched) all in the nose section, and nothing else in any of the other sections. This state of activation will continue until the master “OFF” switch 100 is activated.

In another embodiment, and in operation of the illustrated invention, adjustment of the device 10 is possible during operation. For example, given the same state of operation as described in the previous paragraph, the user may decide that the middle section 16, needs to be vibrating. This is accomplished by pressing button number 2 and pressing “VIBRATE”, and select a medium level of intensity by touching half way up the pyramid sliding switch 90. Now, two separate sections, nose and middle, are activated with different sets of features and different levels of intensities.

Accordingly, the present invention has been developed to provide greater independent control over several features that are dispersed along a longitudinal axis of the elongated massage device 10.

While the methods and processes described in the present invention have proven to be particularly useful in the area of massages, those skilled in the art can appreciate that the device and methods can be used in a variety of different applications and in a variety of areas of the human anatomy to yield improvements in sensory stimulation.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the references have taught to use a single elongated profile for the stimulation device 10 throughout the specification, one skilled in the art will realize after reading the specification that there are many other profiles and designs for the illustrated embodiments of the invention. Specifically, there are double bulbed noses that could also work, as one additional embodiment, and each bulb or nose could operate differently. Moreover, a large flat design could also work, with portions of the flat are being divided into sections to separately control. Wherein, it is envisioned that any type of structural design can be accommodated for increased features and controls.

Additionally, although the figures illustrate only a single design for the control panel, one skilled in the art will realize that there are an infinite number of control panel designs that can be used. For example, the panel could be oblong, rounded, different names, different locations for features, etc.

It is also envisioned that the illustrated embodiment of the divisions between the sections of the massager 10 could be most any known design. The main point of the division designs is to dampen the effect from one section to the next. For example, vibration in the middle has little effect on the nose and rear sections. However, it is known that there will be some impact between sections, but having reduced effect is the practical goal.

While the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is desired by Letters Patent, as enabled by the U.S. Constitution under Section 8, clause 8, “for the promotion of the useful arts”, is claimed herein:

1. A massage device, comprising:
a) a first and second section;
b) a vibration isolation device, positioned between the first and second section, designed to dampen vibrations occurring in the first section from fully impacting the second section; and
c) a first and second vibrator motor positioned in the first and second section respectively, designed to be independently operated from each other.

2. The massage device of claim 1, further comprising:
a) a first and second lubrication port, located in the first and second section respectively; and
b) a lubrication pump module located in the massage device, designed to independently provide lubrication between the first and second lubrication port.

3. The massage device of claim 2, further comprising:
a) a first and second temperature module, located in the first and second section respectively; and
b) a control module, located in the massage device, designed to independently provide independent activation control over the first and second temperature module.

4. The massage device of claim 2, further comprising a lubrication storage container, coupled to the lubrication pump module, designed to supply lubrication thereto.

5. The massage device of claim 3, further comprising a control module, designed to provide functional independent control to the temperature module, lubrication pump module, and the first and second vibrator motor respectively.

6. The massage device of claim 5, further comprising a control panel, positioned on the outside surface of the massage device, designed to provide tactile control switches so the user may individually control the operation of the first and second temperature module, first and second lubrication port, and the first and second vibrator motor positioned in the first and second sections respectively.

7. The massage device of claim 4, further comprising a control panel, positioned on the outside surface of the massage device, designed to provide tactile control switches so the user may individually control the operation of the first and second temperature module, first and second lubrication port, and the first and second vibrator motor positioned in the first and second sections respectively.

8. A massage device, comprising:
a) a first and second section;
b) a vibration isolation device, positioned between the first and second section, designed to dampen vibrations occurring in the first section from fully impacting the second section;
c) a first and second vibrator motor positioned in the first and second section respectively, designed to be independently operated from each other;
d) a first and second lubrication port, located in the first and second section respectively;
e) a lubrication pump module located in the massage device, designed to independently provide lubrication to the first and second lubrication port;
f) a first and second temperature module, located in the first and second section respectively;
g) a control module, located in the massage device, designed to independently provide independent activation control over the first and second temperature module;
h) a lubrication storage container, coupled to the lubrication pump module, designed to supply lubrication thereto;
i) a control module, designed to provide functional independent control to the temperature module, lubrication pump module, and the first and second vibrator motor respectively; and
j) a control panel, positioned on the outside surface of the massage device, designed to provide tactile control switches so the user may individually control the operation of the first and second temperature module, first and second lubrication port, and the first and second vibrator motor positioned in the first and second sections respectively.
